(19) United States
(12) Patent Application Publication
(10) Pub. No.: US 2017/0063601 A1
(43) Pub. Date: Mar. 2, 2017

(54) COMMUNICATION CONTROL DEVICE THAT CONTROLS NETWORK DEVICE IN TRANSMISSION SYSTEM

(71) Applicant: FUJITSU LIMITED, Kawasaki-shi (JP)

(72) Inventor: Tadayuki Takada, Shinagawa (JP)

(73) Assignee: FUJITSU LIMITED, Kawasaki-shi (JP)

(21) Appl. No.: 15/194,889

(22) Filed: Jun. 28, 2016

(30) Foreign Application Priority Data
Aug. 27, 2015 (JP) 2015-167490

(51) Int. Cl. H04L 12/24; H04L 29/06

(52) U.S. Cl. CPC H04L 41/0654; H04L 69/16; H04L 69/08; H04L 41/20

(57) ABSTRACT

A communication control device includes: a first storage configured to store control information in a first protocol; a conversion unit configured to convert the control information in the first protocol into control information in a second protocol; a second storage configured to store the control information in the second protocol; a transmitter configured to transmit the control information in the second protocol to a network device; and a receiver configured to receive a completion notice from the network device. When the receiver does not receive the completion notice, the transmitter transmits, to the network device, cancelling information that cancels the control information in the second protocol previously transmitted to the network device or the control information in the second protocol stored in the second storage according to an amount of the control information in the first protocol stored in the first storage.

### CROSS-REFERENCE TO RELATED APPLICATION

This application is based upon and claims the benefit of priority of the prior Japanese Patent Application No. 2015-167490, filed on Aug. 27, 2015, the entire contents of which are incorporated herein by reference.

### FIELD

The embodiments discussed herein are related to a transmission system and a communication control device that controls a network device in the transmission system.

### BACKGROUND

In recent years, there are cases where cloud services, video content distribution, etc. that utilize smartphones and the Internet cause a sharp change in the demand for traffic in a short period of time. In view of this situation, a method is proposed that realizes flexible changes in the configuration of a network by defining the network by means of software (SDN (Software Defined Network) for example).

Meanwhile, network elements configuring a network have conventionally been controlled and managed by methods that vary between individual venders of such network elements. For example, a management system provided for each vender controls the configuration and the state of each network element. Due to this, it has been difficult to make a flexible or immediate change in the configuration of a network that includes network elements provided by a plurality of different venders.

In order to solve this problem, an open interface that uses a common procedure for controlling network elements from different venters has been spread. As an example of such open interfaces, OpenFlow is known.

However, a network element that does not interpret OpenFlow messages may sometimes be included in a network. In such a case, OpenFlow messages are to be converted into a language (TL1 (Transaction Language 1) for example) that such a network element can interpret. Thus, a network like this is provided with a converter for converting OpenFlow messages into TL1 commands.

The converter converts an OpenFlow message for controlling a network element into a TL1 command so as to transmit the command to a corresponding network element. Then, the network element changes the operation state in accordance with the received TL1 command. Thereby, a network configuration is realized in accordance with OpenFlow messages. In the above process, the management system updates a database for managing a network element in accordance with an instruction to change the settings based on an OpenFlow message.

As a related technology, a communication service system that processes TL1 messages is proposed (Japanese Laid-open Patent Publication No. 10-145492, for example).

In the above network, a failure between a converter and a network element causes inconsistency between the network element and the management system. Specifically, the state of the network element managed by the database of the management system and the actual state of that network element may become inconsistent. In such a case, the management system does not manage the network properly, leading to a possibility that appropriate communication services will not be provided.

Inconsistency between a network element and the management system is cancelled manually by for example the user or the network administrator after the recovery from the failure between the converter and the network element. This sometimes results in a case where a long time is taken for a network element to restore the normal operation state after the recovery from the failure between the converter and the network element.

### SUMMARY

According to an aspect of the embodiments, a communication control device includes: a first receiver configured to receive control information in a first protocol; a first storage configured to store the control information in the first protocol received by the first receiver; a conversion unit configured to convert the control information in the first protocol stored in the first storage into control information in a second protocol; a second storage configured to store the control information in the second protocol; a transmitter configured to transmit the control information in the second protocol stored in the second storage to a network device; and a second receiver configured to receive a completion notice from the network device, the completion notice indicating that the network device has received the transmitted control information in the second protocol. When the second receiver does not receive the completion notice within a specified period of time counting from when the transmitter transmitted the control information in the second protocol to the network device, the transmitter transmits, to the network device, cancelling information that cancels the control information in the second protocol previously transmitted to the network device or the control information in the second protocol stored in the second storage according to an amount of the control information in the first protocol stored in the first storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a transmission system;

FIG. 2A and FIG. 2B illustrate an example of conversion from an OpenFlow message into a TL1 command;

FIG. 3 illustrates an example of a converter;

FIG. 4A and FIG. 4B illustrate another example of conversion from an OpenFlow message into a TL1 command;

FIG. 5A and FIG. 5B illustrate examples of a general TL1 command and a cancellation TL1 command;

FIG. 6 and FIG. 7 are flowcharts illustrating an example of an operation of a converter according to a first embodiment;

FIG. 8 illustrates an example of a TL1 command transmitted at a time of the occurrence of a failure;

FIG. 9 is a flowchart illustrating an example of an operation of a controller;

FIG. 10 illustrates an example of a sequence of controlling network elements by using a barrier request message; and

FIG. 11 is a flowchart illustrating an example of an operation of a converter according to a second embodiment.

### DESCRIPTION OF EMBODIMENTS

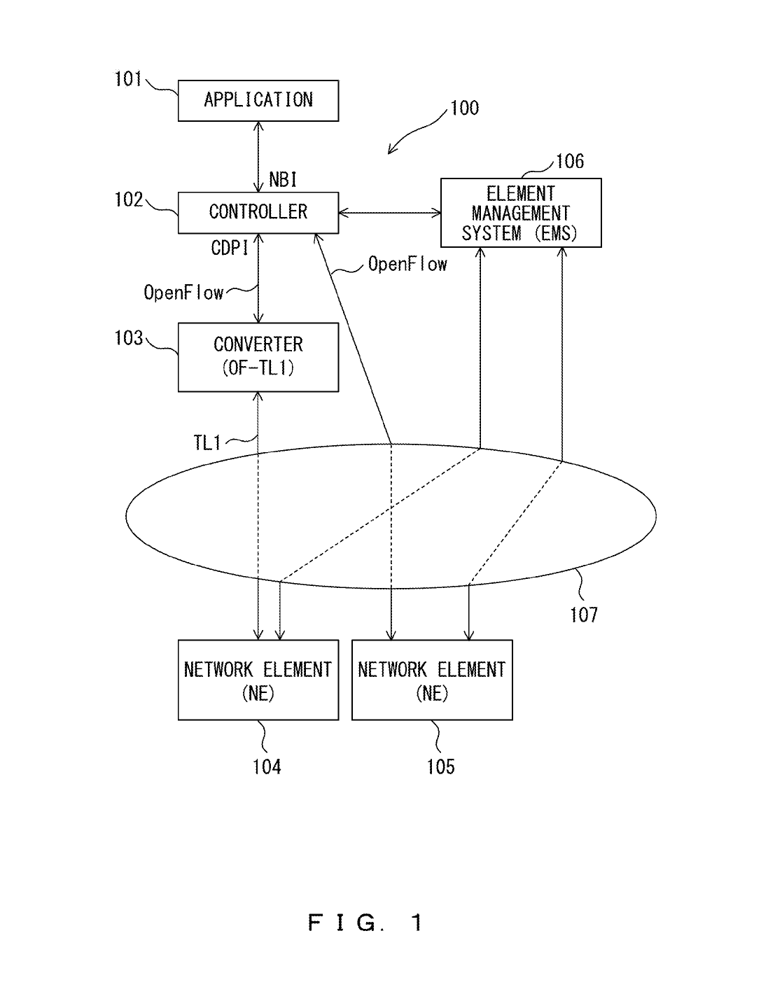

FIG. 1 illustrates an example of a transmission system according to an embodiment of the present invention. As illustrated in FIG. 1, a transmission system 100 according to the embodiment includes an application 101, a controller 102, a converter 103, a network element (NE) 104, a network element (NE) 105, and an element management system (EMS) 106. The controller 102, the converter 103, the network elements 104 and 105 and the element management system 106 are connected to a control-system network 107. The control-system network 107 supports for example TCP/IP. The transmission system 100 may further include a device or an element that is not illustrated in FIG. 1. Note that a network element (NE) is an example of a network device, and an element management system (EMS) is an example of a management system.

The application 101 requests settings for a communication service that is provided by a network including the network elements 104 and 105. This request is fed to for example the NBI (Northbound Interface) of the controller 102. The application 101 is executed by the user or the network administrator.

Based on a request fed by the application 101, the controller 102 generates an OpenFlow message for controlling the network elements 104 and 105. This message is transmitted via for example a CDPI (Controller Data Plane Interface). The controller 102 notifies the element management system 106 of setting information, which represents the content of the generated OpenFlow message.

It is assumed in this example that the network element 105 can interpret OpenFlow messages while the network element 104 does not interpret OpenFlow messages. Accordingly, the converter 103 is provided between the controller 102 and the network element 104.

The converter 103 converts OpenFlow messages into a language that the network element 104 can interpret. It is assumed in this example that the network element 104 operates by interpreting TL1. Thus, the converter 103 conducts protocol conversion between OpenFlow messages and TL1. In other words, an OpenFlow message transmitted from the controller 102 to the network element 104 is converted by the converter 103 into a TL1 command and is fed to the network element 104. Note that the converter 103 is an example of a communication control device that processes messages between the controller 102 and the network element 104.

The network elements 104 and 105 provide a communication service in response to a request from the application 101. The network element 104 changes the operation state of the network element 104 in accordance with a TL1 command and the network element 105 changes the operation state of the network element 105 in accordance with an OpenFlow message. Then, the network element 104 and 105 respectively notify the element management system 106 of the settings of themselves. The network elements 104 and 105 correspond to for example a switch, a router, a reconfigurable optical add-drop multiplexer (ROADM), etc.

The element management system 106 conducts communications with the network elements 104 and 105 via the control-system network 107 so as to manage the network elements 104 and 105. For example, the element management system 106 can manage the failure state, the settings, the account, the performance, the security, etc. of each of the network elements 104 and 105. Thus, the element management system 106 includes a database for managing the network elements 104 and 105.

Information is exchanged between the controller 102 and the element management system 106. Specifically, the controller 102 and the element management system 106 share setting information of the network elements 104 and 105. When for example the controller 102 has issued an OpenFlow message so as to change the settings of the network element 104, the element management system 106 is notified, by the controller 102, of the setting information representing the changing content. Thereby, the element management system 106 can manage the latest settings of the network element 104.

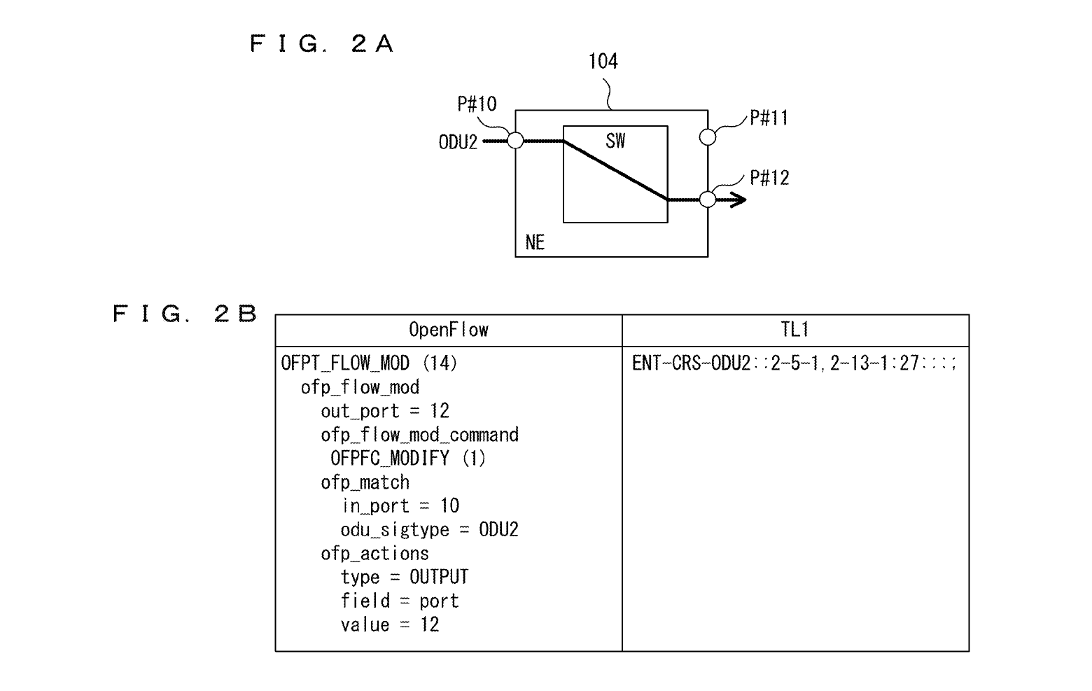

FIG. 2A and FIG. 2B illustrate an example of conversion from an OpenFlow message into a TL1 command. In this example, the network element 104 is provided with a switch fabric as illustrated in FIG. 2A. The application 101 requests that “ODU2 signal that is input via port P#10 be output via port P#12”.

In such a case, the controller 102 generates the OpenFlow message illustrated in FIG. 2B. The converter 103 converts this OpenFlow message into a TL1 command. Then, the network element 104 changes the settings of the switch fabric in accordance with the TL1 command fed by the converter 103.

It is assumed in the transmission system 100 illustrated in FIG. 1 that the link between the converter 103 and the network element 104 has been disconnected. In such a case, a TL1 command transmitted from the converter 103 does not reach the network element 104. Meanwhile, the controller 102 notifies the element management system 106 of setting information that represents the content of the TL1 command transmitted to the network element 104. As a result of this, inconsistency occurs between the content of the database included in the network element 104 and that of the database included in the element management system 106. Specifically, the settings of the network element 104 managed by the database of the element management system 106 and the actual settings of the network element 104 becomes inconsistent. In such a case, the element management system 106 does not manage the network properly, leading to a possibility that appropriate communication services will not be provided.

After the recovery of the link between the converter 103 and the network element 104, the consistency between the network element 104 and the element management system 106 is to be restored. In this situation, resuming the transmission of a TL1 command from the converter 103 to the network element 104 after the recovery from the link failure may restore the consistency between the network element 104 and the element management system 106. However, when for example a plurality of OpenFlow messages were issued consecutively for controlling the network element 104, the consistency between the network element 104 and the element management system 106 is not restored in some cases even when the transmission of a TL1 is resumed after the recovery from the link failure. Also, in such a case, the user or the network administrator conducts troublesome operations for restoring the consistency between the network element 104 and the element management system 106.

Accordingly, the converter 103 is provided with a function of determining an operation after the recovery from a link failure in accordance with the state of a network. As an example, the converter 103 can simply resume the transmission of a TL1 command after the recovery from a link failure or can return the settings of the network element 104 to the state before the occurrence of the link failure. In such a case, when requests for controlling the network element 104 are generated by the network element 104 with a low frequency, the converter 103 may simply resume the transmission of a TL1 command. When requests for controlling the network element 104 are generated with a high frequency, the converter 103 may return the settings of the network element 104 to the state before the occurrence of a link failure.

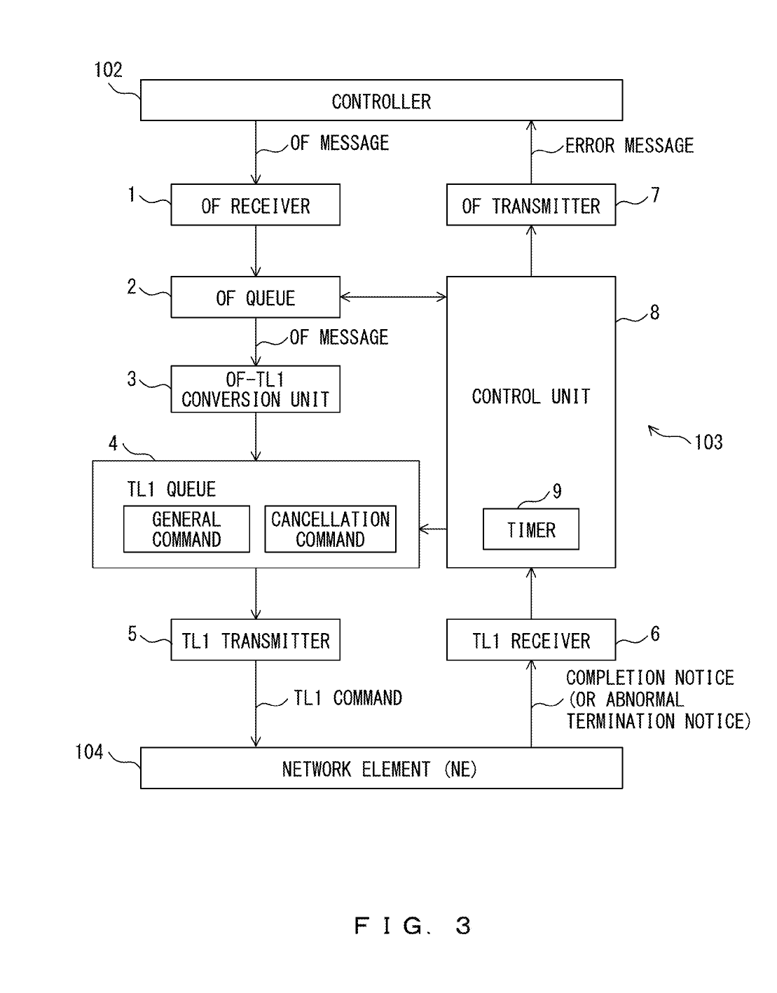

FIG. 3 illustrates an example of the converter 103. As illustrated in FIG. 3, the converter 103 includes an OF receiver 1, an OF queue 2, an OF-TL1 conversion unit 3, a TL1 queue 4, a TL1 transmitter 5, a TL1 receiver 6, an OF transmitter 7 and a control unit 8. Note that the converter 103 may include a device or element that is not illustrated in FIG. 3. Also, an OpenFlow herein may also be referred to as an “OF”.

The OF receiver 1 receives an OF message from the controller 102. An OF message is generated by the controller 102 in accordance with a request transmitted from the application 101. Also, an OF message gives an instruction to conduct settings (i.e., the circuit configuration, the operation state, etc.) of the network element 104. The OF receiver 1 sequentially stores the received OF messages in the OF queue 2. The OF queue 2 is implemented by a FIFO (First-In First-Out) memory.

The OF-TL1 conversion unit 3 sequentially reads OF messages stored in the OF queue 2, and converts each OF message into a TL1 command. In the example illustrated in FIG. 2B, an OF message is converted into one TL1 command. However, an OF message may be converted into a plurality of TL1 commands in some cases.

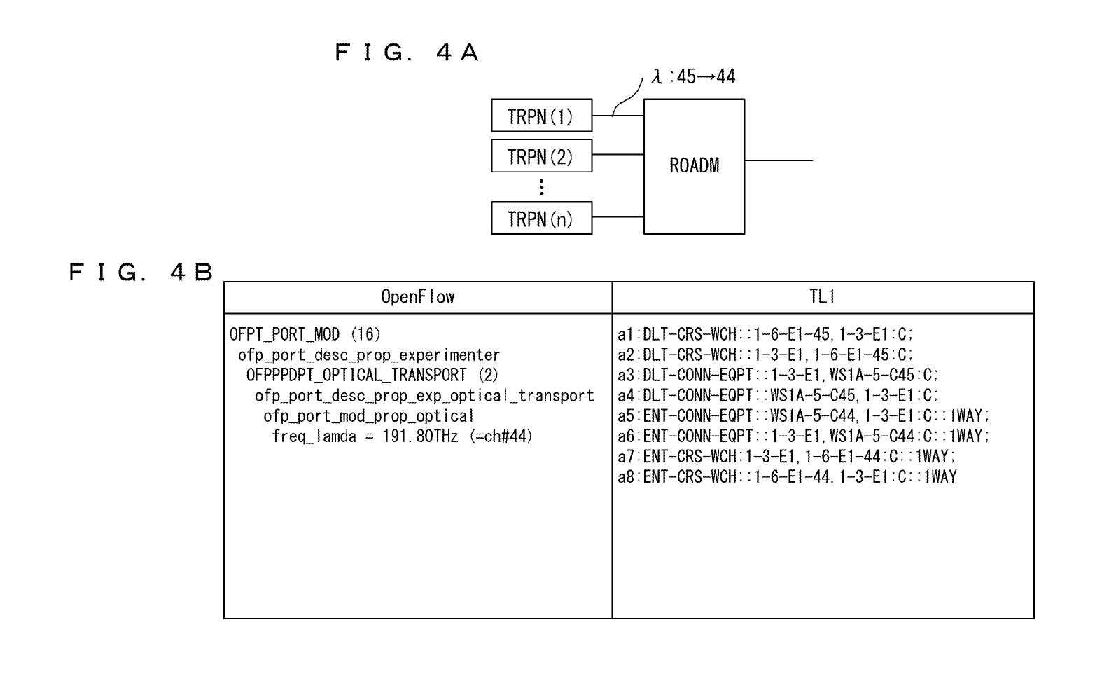

FIG. 4A and FIG. 4B illustrate another example of conversion from an OpenFlow message into a TL1 command. In this example, the network element 104 includes a plurality of transponders TRPN (1) through TRPN (N) and a reconfigurable optical add-drop multiplexer (ROADM) as illustrated in FIG. 4A. The application 101 requests that “a wavelength channel used by transponder TRPN (1) be changed from λ45 to λ44”. In such a case, the controller 102 generates the OF message illustrated in FIG. 4B. Then, the converter 103 converts this OF message into eight TL1 commands a1-a8. TL1 commands a1 and a2 delete wavelength path λ45 established in the ROADM. TL1 commands a3 and a4 delete wavelength path λ45 established between transponder TRPN (1) and the ROADM. TL1 commands a5 and a6 establishes wavelength path λ44 between transponder TRPN (1) and the ROADM. TL1 commands a7 and a8 establishes wavelength path λ44 in the ROADM.

When converting an OF message into a TL1 command, the OF-TL1 conversion unit 3 generates a TL1 command for cancelling a process that is based on the TL1 command obtained by the conversion. Hereinbelow, a TL1 message representing an instruction of an OF message may be referred to as a “general TL1 command”. Also, a TL1 command for cancelling a process that is based on a general TL1 command may be referred to as a “cancellation TL1 command”.

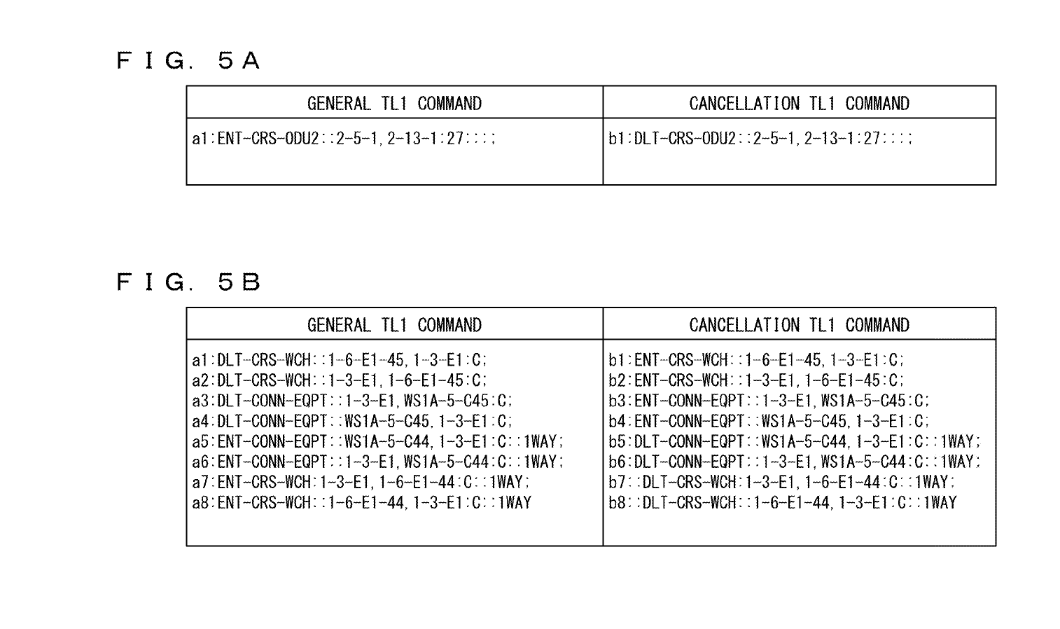

FIG. 5A illustrates examples of TL1 commands generated from the OF message illustrated in FIG. 2B. In this example, a general TL1 command a1 and a cancellation TL1 command b1 are generated. General TL1 command a1 gives an instruction to execute “CRS-ODU2::2-5-1,2-13-1:27”. Cancellation TL1 command b1 gives an instruction to delete “CRS-ODU2::2-5-1,2-13-1:27”. Accordingly, when normal TL1 command a1 has been executed in the network element 104 and then the cancellation TL1 command b1 has been executed in the network element 104, the settings of the network element 104 returns to the state before the execution of general TL1 command a1. It is assumed for example the general TL1 command a1 changes the settings of the network element 104 from X to Y. In the present case, the cancellation TL1 command b1 returns the settings of the network element 104 from Y to X.

FIG. 5B illustrates an example of TL1 commands generated from the OF message illustrated in FIG. 4B. In this example, the normal TL1 commands a1-a8 and the cancellation TL1 commands b1-b8 are generated. The cancellation TL1 commands b1-b8 can respectively delete the processes that are based on their corresponding general TL1 commands a1-a8.

TL1 commands (general TL1 commands and cancellation TL1 commands) generated by the OF-TL1 conversion unit 3 are sequentially stored in the TL1 queue 4. The TL1 queue 4 is implemented by for example a FIFO (First-In First-Out) memory.

The TL1 transmitter 5 sequentially reads TL1 commands stored in the TL1 queue 4, and transmits each TL1 command to the network element 104. During this process, the TL1 transmitter 5 selects a general TL1 command or a cancellation TL1 command so as to transmit the selected command to the network element 104 in accordance with an instruction from the control unit 8. When the process specified by the received TL1 command has been completed, the network element 104 transmits a completion notice (COMPLD) to the converter 103. Also, when the process specified by the TL1 command was not successfully executed, the network element 104 transmits an abnormal termination notice (DENY) to the converter 103. The TL1 receiver 6 receives the notice from the network element 104 and feeds the notice to the control unit 8.

The OF transmitter 7 transmits an OF message to the controller 102 in accordance with an instruction from the control unit 8. When for example a TL1 command has not been successfully processed in the network element 104, the OF transmitter 7 transmits an error message (OFPT-ERROR-MSG) to the controller 102. Also when an OF message received from the controller 102 has not been converted into a TL1 command properly, the OF transmitter 7 may transmit an error message to the controller 102.

The control unit 8 controls the operation of the converter 103. For example, when the link is normal between the converter 103 and the network element 104, the control unit 8 controls the TL1 transmitter 5 so that the TL1 transmitter 5 reads a general TL1 command from the TL1 queue 4 to transmit the command to the network element 104. Also, when a failure is detected in the link between the converter 103 and the network element 104, the control unit 8 decides whether or not to transmit a cancellation TL1 command to the network element 104. When the control unit 8 decides to transmit a cancellation TL1 command to the network element 104, the control unit 8 controls the TL1 transmitter 5 so that the TL1 transmitter 5 reads a cancellation TL1 command from the TL1 queue 4 to transmit the command to the network element 104. The control unit 8 may transmit an error message to the controller 102 via the OF transmitter 7 when a failure is detected in the link between the converter 103 and the network element 104.

The control unit 8 is implemented by for example a processor system including a processor element and a memory. In such a case, the processor system executes a given program so as to provide the functions of the control unit 8. In this example, the processor system may provide the function of the OF-TL1 conversion unit 3 in addition to the function of the control unit 8. Note that the function of the control unit 8 may partially be implemented by a hardware circuit.

The control unit 8 monitors the state of the link between the converter 103 and the network element 104 by using for example the following methods.

Monitoring method 1: The control unit 8 monitors whether the TL1 receiver 6 receives a corresponding completion notice within a specified period of time after when a TL1 command is transmitted from the TL1 transmitter 5 to the network element 104.
Monitoring method 2: The control unit 8 monitors whether an idle pulse has been received from the network element 104. An idle pulse is realized by for example FastLinkPulse of the IEEE or NormalLinkPulse of 10BASE-T.
Monitoring method 3: The control unit 8 monitors a response to ping transmitted to the network element 104.

The control unit 8 includes a timer 9. The timer 9 is used when monitoring method 1 above is executed. Specifically, the timer 9 is reset when a TL1 command is transmitted to the network element 104 and starts to clock the time. When a specified period of time has elapsed after being reset, the timer 9 outputs an expiration signal. The “specified period of time” may be determined in accordance with the configuration of the network, a request from the user, etc. The “specified period of time” may be determined to be shorter in a network in which the changing of the configuration is requested frequently.

It is assumed in the following descriptions that the control unit 8 uses monitoring method 1 above to monitor the state of the link between the converter 103 and the network element 104. Specifically, when the TL1 receiver 6 does not receive a corresponding completion notice within a specified period of time after when a TL1 command is transmitted from the TL1 transmitter 5 to the network element 104, the control unit 8 determines that one of the following failures has occurred.

(1) A TL1 command transmitted from the converter 103 does not reach the network element 104.
(2) A TL1 command is executed normally in the network element 104 and a completion notice is transmitted from the network element 104 toward the converter 103, but that completion notice does not reach the converter 103.
(3) A TL1 command is not successfully executed in the network element 104 and an abnormal termination notice is transmitted from the network element 104 to the converter 103, but that abnormal termination notice does not reach the converter 103.

Upon detecting a failure as described above, the converter 103 transmits a cancellation TL1 command to the network element 104 as needed. Here, the cancellation TL1 command corresponds to the TL1 command that was transmitted previously (i.e., a general TL1 command). It is assumed as an example that the settings of the network element 104 is “X” and a general TL1 command includes an instruction to change the settings from “X” to “Y”. It is also assumed that the cancellation TL1 command includes an instruction to return the settings from “Y” to “X”.

When the converter 103 fails to receive a completion notice due to failure (2) above, the settings of the network element 104 has been changed by a general TL1 command from “X” to “Y”. Accordingly, when a cancellation TL1 command is fed to the network element 104, the settings of the network element 104 returns to “X” from “Y”. When the converter 103 fails to receive a completion notice due to failure (1) or (3) above, a general TL1 command has not been executed in the network element 104. In other words, the settings of the network element 104 remains “X”. In such a case, the settings of the network element 104 remains “X” unless the cancellation TL1 command reaches the network element 104. Further, even when the cancellation TL1 command reaches the network element 104, the settings of the network element 104 is controlled by that cancellation TL1 command so that the settings is to be “X” and accordingly the settings of the network element 104 remains “X”. In other words, even when any of failures (1) through (3) above has occurred, the settings of the network element 104 after the transmission of a cancellation TL1 command to the network element 104 remains the same as the settings before the transmission of the previous general TL1 command.

As described above, the control unit 8 controls the operation of the TL1 transmitter 5 and the operation of the OF transmitter 7. In other words, the transmission function of the converter 103 is realized by the TL1 transmitter 5, the OF transmitter 7 and the control unit 8.

### First Embodiment

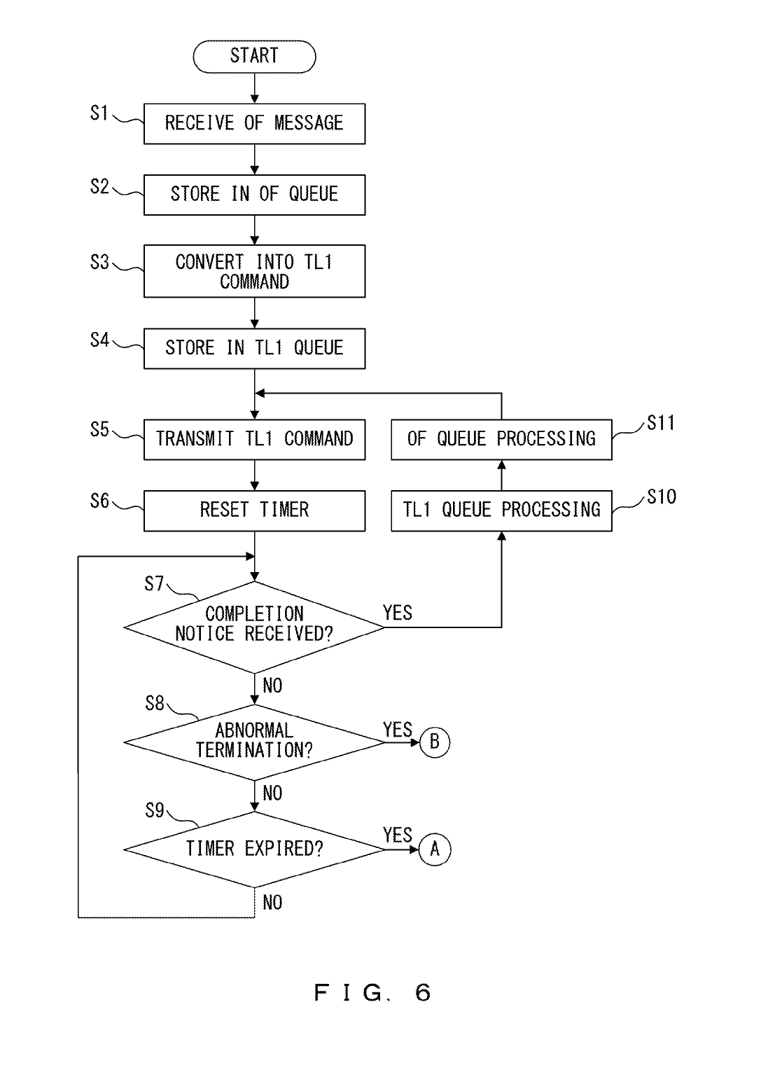

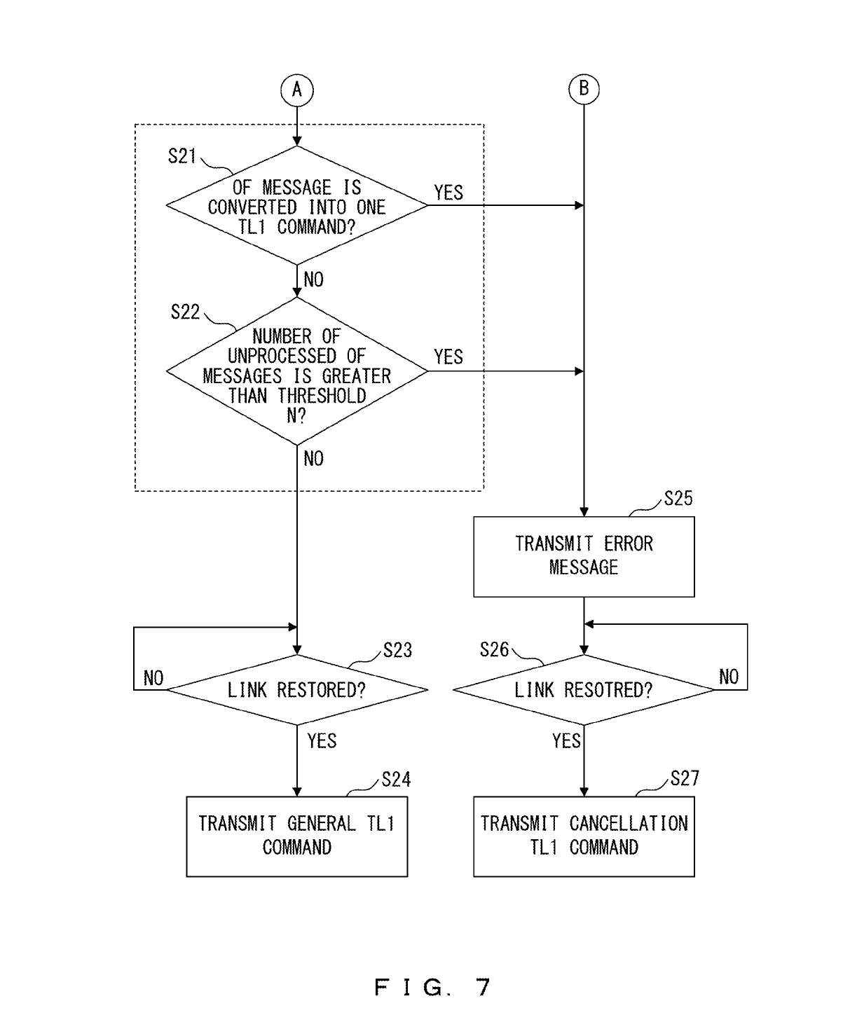

FIG. 6 and FIG. 7 are flowcharts illustrating an example of the operation of the converter 103 according to a first embodiment. The operation illustrated in FIG. 6 and FIG. 7 is executed when the controller 102 generates an OF message for controlling the network element 104 and transmits the message to the converter 103.

In S1 and S2, the OF receiver 1 receives an OF message transmitted from the controller 102. Then, the OF receiver 1 stores the received OF message in the OF queue 2.

In S3, the OF-TL1 conversion unit 3 extracts the OF message from the OF queue 2 so as to convert the message into a TL1 command. In the above process, the OF-TL1 conversion unit 3 generates a general TL1 command representing an instruction of the OF message and a cancellation TL1 command corresponding to that general TL1 command. As described above, the cancellation TL1 command includes an instruction to restore the state before the execution of the process based on the corresponding general TL1 command. Then, in S4, the OF-TL1 conversion unit 3 stores the generated TL1 commands (general TL1 command and cancellation TL1 command) in the TL1 queue 4.

In S5 and S6, the TL1 transmitter 5 extracts a general TL1 command stored in the TL1 queue 4 and transmits the command to the network element 104 in accordance with an instruction from the control unit 8. In the above process, the control unit 8 resets the timer 9. In other words, when a general TL1 command is transmitted to the network element 104, the timer 9 starts to clock the time.

In S7-S9, the control unit 8 waits for a notice that is transmitted from the network element 104. When the network element 104 receives a completion notice from the network element 104 before the expiration of the timer 9, the control unit 8 decides that a general TL1 command has been successfully executed in the network element 104. In other words, the control unit 8 decides that the settings of the network element 104 has been changed by the general TL1 command. In such a case, in S10, the control unit 8 deletes from the TL1 queue 4 the general TL1 command that was transmitted to the network element 104 in 5105 and the cancellation command corresponding to that general TL1 command. Also, in S11, the control unit 8 deletes from the OF queue 2 the OF message corresponding to the general TL1 command transmitted in S5. Thereafter, the process of the control unit 8 returns to S5.

When one OF message is converted into a plurality of TL1 commands (i.e., a plurality of sets of general TL1 commands and cancellation TL1 commands), the control unit 8 executes S10 and S11 upon receiving the completion notices for all such TL1 commands corresponding to that OF message. For example, when general TL1 commands a1-a8 and cancellation TL1 commands b1-b8 illustrated in FIG. 5B have been generated, general TL1 commands a1-a8 and cancellation TL1 commands b1-b8 are deleted from the TL1 queue 4 after general TL1 commands a1-a8 are transmitted to the network element 104 and the control unit 8 receives all the completion notices corresponding to general TL1 commands a1-a8. Also, the OF message corresponding to general TL1 commands a1-a8 are deleted from the OF queue 2.

When the control unit 8 receives an abnormal termination notice from the network element 104 (Yes in S8), the process of the control unit 8 proceeds to S25. Also, when the timer 9 has expired before receiving a completion notice from the network element 104 (Yes in S9), the process of the control unit 8 proceeds to S21.

In S21 and S22, the control unit 8 decides whether or not to return the settings of the network element 104 to the state before the transmission of a general TL1 command. In this example, the control unit 8 decides in S21 whether the OF message received in S1 has been converted into one general TL1 command or into a plurality of general TL1 commands. When the OF message has been converted into one general TL1 command, the control unit 8 executes S25-S27 in order to restore the settings of the network element 104. When the OF message has been converted into a plurality of general TL1 commands, the process of the control unit 8 proceeds to S22. In S22, the control unit 8 decides whether or not the number of unprocessed OF messages is greater than a specified threshold N. Specifically, the control unit 8 decides whether or not the number of OF messages remaining in the OF queue 2 is greater than the threshold N. When the number of the OF messages is greater than the threshold N, the control unit 8 executes S25-S27 in order to restore the settings of the network element 104. When the number of the OF messages is smaller than or equal to the threshold N, the process of the control unit 8 proceeds to S23.

When the number of the unprocessed OF messages is smaller than or equal to the threshold N, the control unit 8 waits in S23 for the restoration of the link between the converter 103 and the network element 104. When for example the link between the converter 103 and the network element 104 is redundant and a failure has occurred in the work link, a protection link is established automatically. The restoration of the link is confirmed by for example monitoring method 2 or 3 described above. In response to the restoration of the link, the control unit 8 resumes the transmission of a general TL1 command remaining in the TL1 queue 4 in S24.

When the number of the unprocessed OF messages is greater than the threshold N or when one OF message has been converted into one general TL1 command, the control unit 8 transmits an error message to the controller 102 via the OF transmitter 7 in S25. This error message includes information indicating that the OF message was not successfully executed. Next, the control unit 8 waits in S26 for the restoration of the link between the converter 103 and the network element 104. When the link is restored, in S27, the control unit 8 transmits to the network element 104 a cancellation TL1 command corresponding to the general TL1 command transmitted previously.

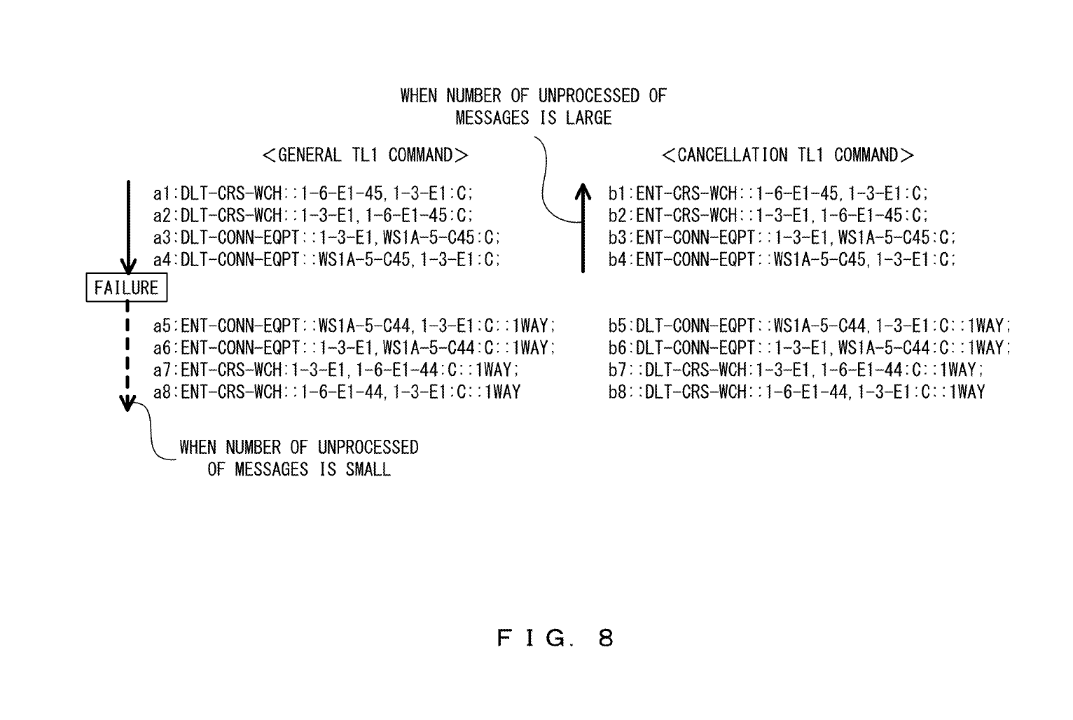

An example thereof will be explained by referring to FIG. 8. In the example illustrated in FIG. 8, the converter 103 is assumed to transmit sequentially general TL1 commands a1-a8 to the network element 104. In such a case, the converter 103 first transmits general TL1 command a1 to the network element 104. Upon receiving a completion notice corresponding to general TL1 command a1, the converter 103 transmits general TL1 command a2 to the network element 104. Similarly, upon receiving a completion notice corresponding to general TL1 command a2, the converter 103 transmits general TL1 command a3 to the network element 104. Also, upon receiving a completion notice corresponding to general TL1 command a3, the converter 103 transmits general TL1 command a4 to the network element 104. However, it is assumed in this example that the converter 103 fails to receive the completion notice corresponding to general TL1 command a4 within a specified period of time.

In such a case, the control unit 8 counts the number of the OF messages stored in the OF queue 2. When the number of the OF messages is smaller than or equal to the threshold N, the converter 103 executes S23 and S24. Specifically, the converter 103 sequentially transmits general TL1 commands a5-a8 to the network element 104 (for example, after restoration of the link). As a result, the network element 104 is set to be in a state specified by general TL1 commands a1-a8.

When the number of the unprocessed OF messages is greater than the threshold N, the converter 103 executes S25-S27. Specifically, the converter 103 transmits an error message to the controller 102. Thereafter, the converter 103 transmits to the network element 104 cancellation TL1 commands b1-b4 corresponding to general TL1 commands a1-a4 that were transmitted preciously. During this transmission, cancellation TL1 commands b1-b4 are transmitted in such a manner that the settings are sequentially cancelled from the general TL1 command that was last transmitted. Specifically, the converter 103 transmits to the network element 104 cancellation TL1 commands b4, b3, b2 and b1 sequentially in this order. As a result, the settings of the network element 104 returns to the state before the transmission of general TL1 commands a1-a4.

As described above, the converter 103 decides whether or not to restore the settings of the network element 104, based on the number of the unprocessed OF messages stored in the OF queue 2. The number of the unprocessed OF messages stored in the OF queue 2 may represent the frequency of changing of the settings of the network by the application 101. Specifically, when the number of the unprocessed OF messages stored in the OF queue 2 is large, it may be considered that the application 101 is attempting to change the settings of the network frequently.

The application 101 issues a next request expecting that the request issued previously will be successfully executed. Therefore, when a TL1 command corresponding to a request from the application 101 has not been successfully executed by the network element 104, it is desirable to notify the application 101 of the process failure as soon as possible. In a case, particularly, when the application 101 changes the settings of the network frequently, and if a plurality of requests to change the settings are issued consecutively before the completion of the changing of the settings of the network element 104, it is difficult to restore the consistency between the actual settings of the network element 104 and the database of the element management system 106. Accordingly, when the number of the unprocessed OF messages stored in the OF queue 2 is large, the settings of the network element 104 is returned to the original state. Also, the converter 103 transmits an error message to the controller 102. When an error message is transmitted from the controller 102 to the application 101, as will be described later, the application 101 halts the issuance of new requests for the network element 104. As a result of this, it becomes easy to recover from the inconsistency between the actual settings of the network element 104 and the database of the element management system 106.

When the number of the unprocessed OF messages stored in the OF queue 2 is small, it is considered that the application 101 changes the settings of the network less frequently. In such a case, even when TL1 commands remaining in the converter 103 are processed sequentially and slowly, the inconsistency does not increase between the actual settings of the network element 104 and the database of the element management system 106. Accordingly, the converter 103 simply resumes the process of transmitting a TL1 command to the network element 104 after the restoration of the link, instead of restoring the settings of the network element 104.

When one OF message is converted into one TL1 command, a cancellation TL1 command is transmitted from the converter 103 to the network element 104 regardless of the number of the OF messages stored in the OF queue 2 in the example illustrated in FIG. 7. However, the present invention is not limited to this method. Specifically, when one OF message is converted into one TL1 command, the control unit 8 may decides whether or not to transmit a cancellation TL1 command to the network element 104 based on the number of the OF messages stored in the OF queue 2. In other words, the control unit 8 does not have to execute the process in S21 illustrated in FIG. 7.

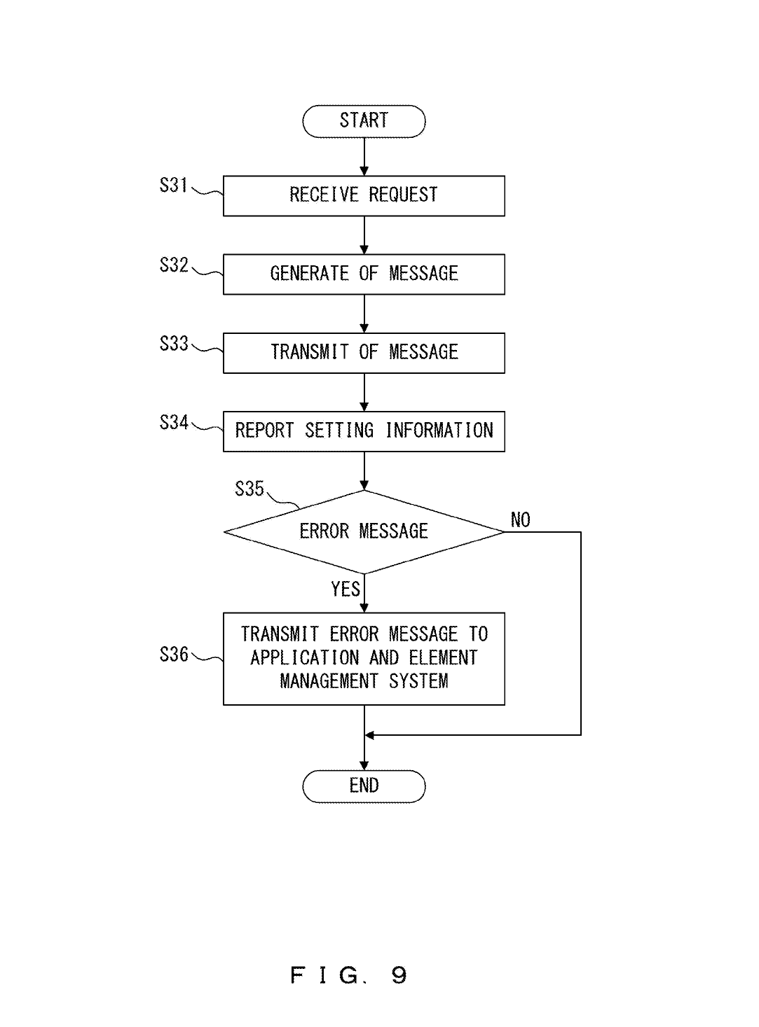

FIG. 9 is a flowchart illustrating an example of an operation of the controller 102. The process of this flowchart is executed when the application 101 issues a request to change the settings of the network element 104.

In S31, the controller 102 receives a request issued by the application 101. In S32, the controller 102 generates an OF message representing the received request. In S33, the controller 102 transmits the generated OF message to the converter 103. In S34, the controller 102 transmits, to the element management system 106, setting information representing the content of the OF message transmitted to the converter 103. In accordance with this setting information, the element management system 106 updates the database for managing the network element 104. Thus, when a TL1 command corresponding to the above OF message is successfully executed in the network element 104, the actual settings of the network element 104 and the database of the element management system 106 become consistent.

In S35, the controller 102 waits for an error message corresponding to the OF message transmitted in S33 to the converter 103. Specifically, the controller 102 waits for the error message transmitted in S25 illustrated in FIG. 7. When receiving the error message from the converter 103, the controller 102 transmits an error message to the application 101 and the element management system 106 in S36. This error message represents that the setting based on the TL1 command previously transmitted to the network element 104 failed. Thus, upon receiving this error message, the application 101 halts the issuance of a request to change the settings of the network element 104. Also, upon receiving this error message, the element management system 106 returns the database of the element management system 106 to the state before the reception of the setting information of S34. As a result, the consistency is restored between the actual settings of the network element 104 and the database of the element management system 106.

As described above, according to the first embodiment, when a link failure has occurred between the converter 103 and the network element 104, the consistency is automatically restored between the actual settings of the network element 104 and the element management system 106 without manual operation of the setting of the network element 104 by the user or the network administrator. This reduces loads on the user or the network administrator.

### Second Embodiment

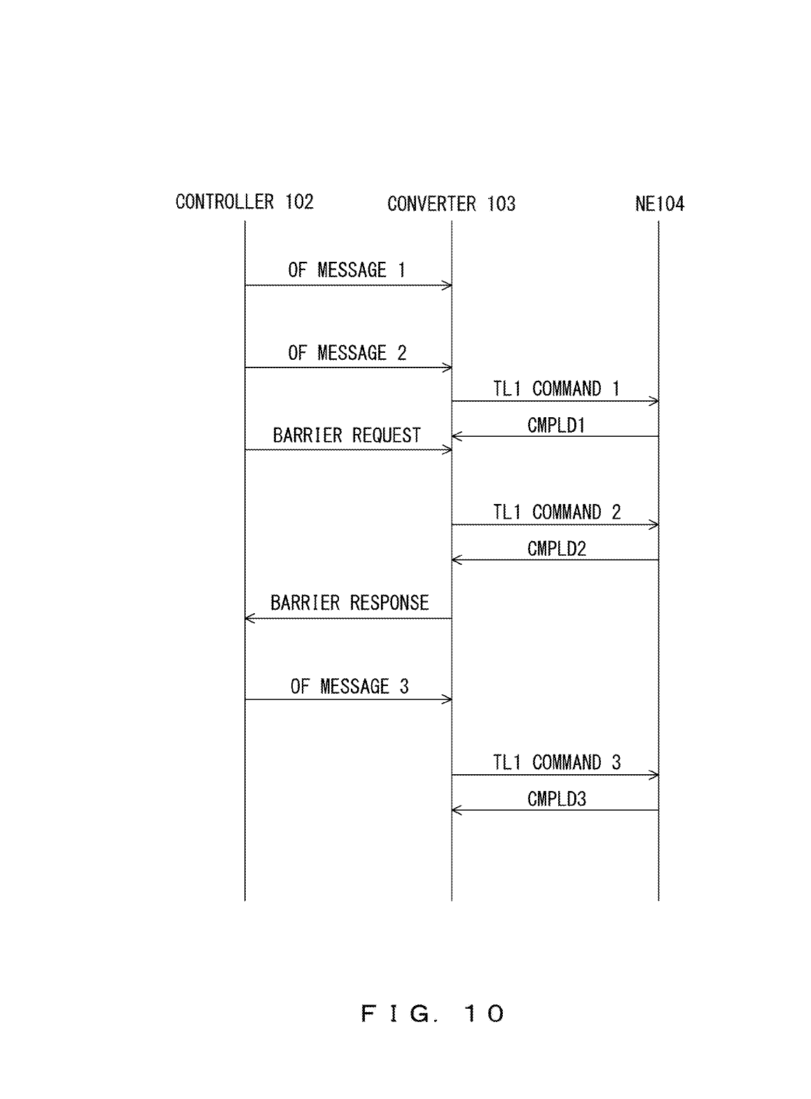

It is requested that OF messages can basically be executed in an arbitrary order. However, as an exceptional case, a barrier request (OFPT_BARRIER_REQUEST) message is used when it is needed to specify the execution order of OF messages. FIG. 10 illustrates an example of a sequence of controlling a network element by using a barrier request message. A barrier request message is generated by the controller 102 in response to a request from the application 101. Note that a barrier request message is a type of OF messages.

In the example illustrated in FIG. 10, OF messages 1-3 are generated for the network element 104. However, it is requested that OF message 3 be executed after the completion of the setting based on OF messages 1 and 2. In such a case, the controller 102 generates a barrier request message and transmits the message to the converter 103 after the transmission of OF messages 1 and 2 and before the transmission of OF message 3.

Upon receiving OF messages 1 and 2 from the controller 102, the converter 103 generates corresponding TL1 commands 1 and 2 and sequentially transmits the commands to the network element 104. Then upon receiving a barrier request message from the controller 102, the converter 103 waits for completion notices corresponding to all OF messages received before that barrier request message. In this example, the converter 103 waits for completion notices corresponding to OF messages 1 and 2. Upon receiving completion notices (CMPLD1 and CMPLD2) corresponding to TL1 commands 1 and 2 from the network element 104, the converter 103 transmits a barrier response message to the controller 102. Thereby, the barrier is cancelled. This makes it possible for the controller 102 to transmit subsequent OF messages. Specifically, the controller 102 transmits OF message 3 to the converter 103.

If the link between the converter 103 and the network element 104 is disconnected while a barrier having been established based on a barrier request message in the above sequence, it is predicted that complicated inconsistency will occur between the network element 104 and the element management system 106. Accordingly, in the second embodiment, the converter 103 selects a TL1 command to be transmitted to the network element 104, in accordance with whether or not a barrier has been established.

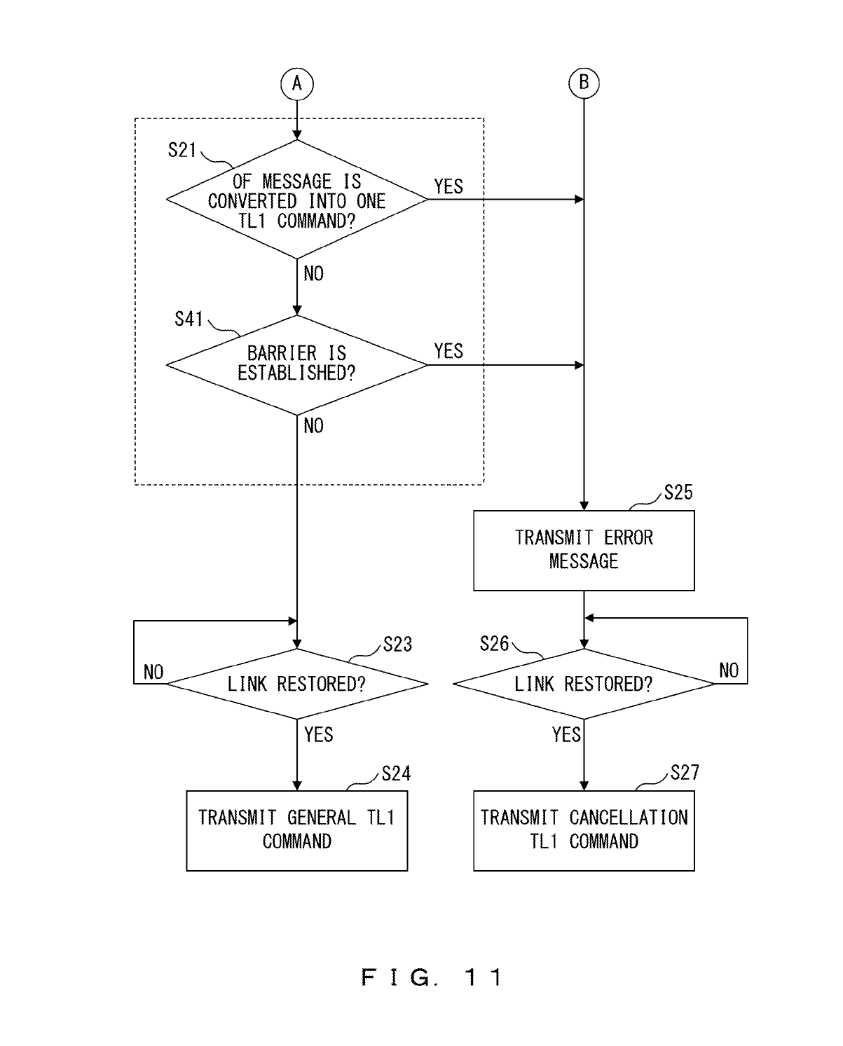

FIG. 11 is a flowchart illustrating an example of an operation of the converter 103 according to a second embodiment. The processes in S1-S11 are substantially the same between the first and second embodiments and thus the explanations thereof will be omitted.

In the second embodiment, S41 is executed instead of S22 illustrated in FIG. 7. In S41, the control unit 8 decides whether or not a barrier has been established. Note that, as explained by referring to FIG. 10, a barrier is in an established state from when a barrier request message is received from the controller 102 until when a corresponding barrier response message is received from the network element 104.

When a barrier has not been established at a time of the detection of a link failure between the converter 103 and the network element 104, the control unit 8 transmits a general TL1 command stored in the TL1 queue 4 to the network element 104 in S24. When a barrier has been established at a time of the detection of a link failure between the converter 103 and the network element 104, the control unit 8 transmits an error message to the controller 102 in S25. Thereafter, the control unit 8 transmits a cancellation TL1 command stored in the TL1 queue 4 to the network element 104 in S27.

As described above, in the second embodiment, when a link failure occurs during a barrier period in which the execution order of OF messages is specified, the setting of the network element 104 is returned to the state before the start of the barrier period. Also, an error message is reported to the application 101 and the element management system 106 via the controller 102. Accordingly, the consistency is secured between the actual settings of the network element 104 and the database of the element management system 106.

As described above, the embodiments of the present invention reduce the labor or the time used for recovering from a failure between a communication control device and a network device in a transmission system including a communication control device that converts control information for controlling the network element into a language that can be interpreted by the network device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A communication control device comprising:
a first receiver configured to receive control information in a first protocol;
a first storage configured to store the control information in the first protocol received by the first receiver;
a conversion unit configured to convert the control information in the first protocol stored in the first storage into control information in a second protocol;
a second storage configured to store the control information in the second protocol;
a transmitter configured to transmit the control information in the second protocol stored in the second storage to a network device; and
a second receiver configured to receive a completion notice from the network device, the completion notice indicating that the network device has received the transmitted control information in the second protocol, wherein
when the second receiver does not receive the completion notice within a specified period of time counting from when the transmitter transmitted the control information in the second protocol to the network device, the transmitter transmits, to the network device, cancelling information that cancels the control information in the second protocol previously transmitted to the network device or the control information in the second protocol stored in the second storage according to an amount of the control information in the first protocol stored in the first storage.

2. The communication control device according to claim 1, wherein
when an amount of the control information in the first protocol stored in the first storage is greater than a specified threshold, the transmitter transmits the cancelling information to the network device.

3. The communication control device according to claim 1, wherein
the conversion unit generates, from control information in the first protocol, control information in the second protocol corresponding to the control information in the first protocol and cancelling information that cancels the control information in the second protocol.

4. The communication control device according to claim 1, wherein
when the transmitter transmits the cancelling information to the network device, the transmitter transmits an error message to a source of the control information in the first protocol.

5. The communication control device according to claim 1, wherein
the transmitter transmits to the network device the cancelling information or the control information in the second protocol stored in the second storage after a link between the communication control device and the network device is restored.

6. The communication control device according to claim 1, wherein
the transmitter transmits the cancelling information to the network device when the second receiver receives from the network device a notice indicating that it is not possible to execute a process based on the control information in the second protocol.

7. A communication control device comprising:
a first receiver configured to receive control information in a first protocol;
a first storage configured to store the control information in the first protocol received by the first receiver;
a conversion unit configured to convert the control information in the first protocol stored in the first storage into control information in a second protocol;
a second storage configured to store the control information in the second protocol;
a transmitter configured to transmit the control information in the second protocol stored in the second storage to a network device; and
a second receiver configured to receive a completion notice from the network device, the completion notice indicating that the network device has received the transmitted control information in the second protocol, wherein
when the second receiver does not receive the completion notice within a specified period of time counting from when the transmitter transmitted the control information in the second protocol to the network device, the transmitter transmits, to the network device, cancelling information that cancels the control information in the second protocol previously transmitted to the network device or the control information in the second protocol stored in the second storage according to whether a process corresponding to a barrier request that specifies an execution order of the control information in the first protocol has been terminated.

8. A transmission system including a network device that does not support OpenFlow, the transmission system comprising:
a controller configured to generate an OpenFlow message;
a converter configured to convert the OpenFlow message generated by the controller into a command in a language supported by the network device and to transmit the resultant command to the network device; and
a management system configured to manage a state of the network device, wherein
the converter includes:
a first receiver configured to receive the OpenFlow message generated by the controller;
a first storage configured to store the OpenFlow message received by the first receiver;
a conversion unit configured to convert the OpenFlow message stored in the first storage into a command in the language supported by the network device;
a second storage configured to store the command obtained by the conversion unit;
a transmitter configured to transmit the command stored in the second storage to the network device; and
a second receiver configured to receive a completion notice from the network device, the completion notice indicating that the network device has received the transmitted command, wherein
when the second receiver does not receive the completion notice within a specified period of time counting from when the transmitter transmitted the command to the network device, the transmitter transmits, to the network device, the command stored in the second storage or a cancellation command that cancels a setting of the network device based on a command previously transmitted to the network device according to a number of the OpenFlow messages stored in the first storage,
when the transmitter transmits the cancellation command to the network device, the transmitter transmits an error message to the controller, and
the controller transmits a message to the management system, the message indicating that the setting based on the command transmitted to the network device failed, when the controller receives the error message.
